(19) United States
(12) Patent Application Publication
(10) Pub. No.: US 2024/0053007 A1
(43) Pub. Date: Feb. 15, 2024

(54) METHOD AND SYSTEM FOR FLAME MONITORING AND CONTROL

(71) Applicant: ANDRITZ OY, Helsinki (FI)

(72) Inventors: Pekka TORMIKOSKI, Savonlinna (FI); Antti TASKINEN, Savonlinna (FI); Timo VIITANEN, Savonlinna (FI); Heikki LAPPI, Kotka (FI); Ossi AALTONEN, Lahti (FI)

(21) Appl. No.: 18/260,762

(22) PCT Filed: Jan. 4, 2022
(86) PCT No.: PCT/FI2022/050006

§ 371 Date: Jul. 7, 2023

(30) Foreign Application Priority Data
Jan. 8, 2021 (FI) 20215014

(51) Int. Cl. F23N 5/26; F27D 21/02; G06V 10/25; G06T 7/62; G06V 20/40; G06V 10/774

(52) U.S. Cl. CPC F23N 5/265; F27D 21/02; G06V 10/25; G06T 7/62; G06V 20/46; G06V 10/774; F23N 2229/20; F23N 2900/05006; F27D 2021/026; G01J 5/0018

(57) ABSTRACT

A method for monitoring a flame of a burner of a lime kiln, including imaging a video stream showing the burner end of the lime kiln; extracting at least one image from the imaged video stream; determining, using a pretrained algorithm, from the at least one image at least one area of interest, wherein the at least one area of interest includes a part of the at least one image showing an area having at least one characteristic portion of the flame and/or burner end; calculating the area of the at least one characteristic portion based on the pixels of the at least one area of interest; and determining at least one quantity of interest based on the calculated area of the at least one characteristic portion.

### TECHNICAL FIELD

The present invention relates to a method and arrangement for flame monitoring and control. In particular, but not exclusively, the present invention relates to a method and arrangement for monitoring and control of the flame of a burner of a lime kiln.

### BACKGROUND

White liquor is produced in a caustisizing process in which green liquor arriving from a recovery boiler reacts with calcium forming white liquor and lime mud. The following chemical reaction takes place:

Na2CO3+CaO+H2O->2NaOH+CaCO3

A lime kiln is used in cellulose manufacturing for producing lime from lime mud for use in preparing white liquor used in the cooking process. A calcining reaction takes place:

CaCO3->CaO+CO2

The calcining reaction requires heat, which is produced in a separate burner using oil, gas or a further fuel. The operation of the lime kiln is adjusted by increasing or decreasing the amount of fuel and by controlling the air delivery at the burner. The amount of remaining calcium carbonate is measured from the produced lime, the level of which is sought to be kept constant.

In case too much fuel is used in the burner or the air delivery is faulty, the temperature might rise too high. In such case, calcium particles will melt, and the lining of the kiln might be damaged. Then again, insufficient fuel will cause a large part of the lime mud to remain unreacted resulting in an inadequate caustisizing process.

Previously, the caustisizing process has been controlled by sampling and measuring the remaining calcium carbonate which did not provide for real time adjustment of the process. Furthermore, methods for monitoring the burning using imaging have been previously disclosed.

It is the object of the present invention to improve the existing solutions by providing a method for monitoring the flame of the burner in order to monitor the caustisizing process and enable an easy and quick control of the process.

### SUMMARY

Various aspects of examples of the invention are set out in the claims.

According to a first example aspect of the present invention, there is provided a method for monitoring a flame of a burner of a lime kiln, comprising
imaging a video stream showing the burner end of the lime kiln;
extracting at least one image from the imaged video stream;
determining, using a pretrained algorithm, from the at least one image at least one area of interest, wherein the at least one area of interest comprises a part of the at least one image showing an area comprising at least one characteristic portion of the flame and/or burner end;
calculating the area of the at least one characteristic portion based on the pixels of the at least one area of interest; and
determining at least one quantity of interest based on the calculated area of the at least one characteristic portion.

The method may further comprise comparing the calculated area and/or the at least one quantity of interest with predetermined threshold values.

The method may further comprise displaying the at least one quantity of interest on a user interface element.

The method may further comprise adjusting the operation of the burner based on the at least one quantity of interest.

The pretrained algorithm may be created by
imaging a video stream showing the burner end of the lime kiln;
extracting a plurality of training images from the imaged video stream and segmenting each image of the plurality of training images into areas of interest, wherein the area of interest for at least one image comprises the interior of the lime kiln; and
training an algorithm to recognize the areas of interest from the segmented images.

The method may further comprise
extracting a reference image from the imaged video stream; and
determining using known dimensions of the lime kiln visible in the reference image corresponding size in SI-units for a pixel of the reference image.

According to a second example aspect of the present invention, there is provided a system for monitoring a flame of a burner of a lime kiln, comprising
imaging means; and
a processor configured to cause carrying out the method of the first example aspect of the present invention.

According to a third example aspect of the present invention, there is provided a computer program comprising computer-executable program code that, when executed by a processor, causes carrying out a method according to the first example aspect.

According to a fourth example aspect of the present invention, there is provided a non-transitory memory medium comprising the computer program of the third example aspect.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows a flow chart of a method according to an example embodiment of the invention;

FIG. 2 shows a further flow chart of a method according to an example embodiment of the invention; and

FIG. 3 shows an example image used in the method according to an example embodiment of the invention.

### DETAILED DESCRIPTION OF THE DRAWINGS

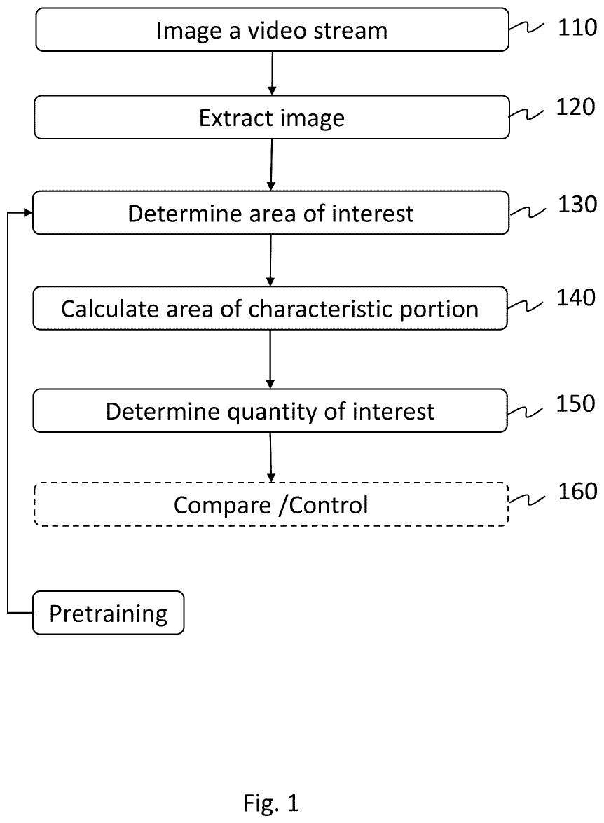

FIG. 1 shows a flow chart of a method according to an example embodiment of the invention. In an embodiment, the method according to an example embodiment of the invention is caused to be carried out by a processor, for example a processor of a control system. In an embodiment, the control system is a standalone control system configured to control the method, for example a local control system or a cloud-based control system. In a further embodiment, the control system is integrated into a mill-wide control system.

At step 110 a video stream showing the burner end of a lime kiln is imaged. In an embodiment, the imaging means for providing the video stream comprise at least one means selected from the group of digital video camera, a digital still camera configured to capture consecutive still images, a high-speed video camera and thermal imaging means. In an embodiment, the camera is installed in a suitable location so that an appropriate area of the burner end of the lime kiln is imaged.

At step 120, at least one image is extracted from the video stream showing the burner end of the lime kiln. The extracted image, or at least a portion thereof, depicts the burner end of the lime kiln. The image is extracted from the video stream using convenient procedures in image and video processing.

At step 130, at least one area of interest is determined from the at least one image, wherein the at least one area of interest comprises a part of the at least one image showing an area comprising at least one characteristic portion of the burner end. In an embodiment, the at least on characteristic portion comprises white flame portion, black flame portion and/or lime bed. Determining the area of interest is carried out using an algorithm pretrained in a manner described in detail hereinafter.

At step 140, the area of the at least one characteristic portion is calculated based on the determined at least one area of interest based on the pixels thereof. In an embodiment, an area in SI-units is determined for the pixels in pretraining the algorithm used. In an embodiment, calculating the area of the at least one characteristic portion comprises calculating a relative area, for example the area of the white flame portion relative to the area of the cross-section of the kiln.

At step 150, at least one quantity of interest is determined based on the calculated area of the at least one characteristic portion. In an embodiment, the at least one quantity of interest is determined based on the calculated area, location or further feature of one or several characteristic portion. In an embodiment, a further feature of the at least one characteristic portion comprises color properties extracted from the image.

In an embodiment, the at least one quantity of interest is determined based on the calculated area, location or further feature of one or several characteristic portions directly or using interim quantities from which the at least one quantity of interest is derived. For example, a flame pumping index based on fluctuation of the length of the flame is in an embodiment calculated using the largest and the smallest length from a certain period of time. In a still further embodiment the at least one calculated quantity of interest is selected from the group of flame angle, black flame area, white flame area, lime area, flame pumping index, dust index inside the kiln, lime back spill area, flame length, flame width and flame tip angle. In an embodiment, the calculated value of the at least one quantity of interest is an absolute value or relative value compared to lime kiln cross section area or a part thereof. In an embodiment, the absolute values comprise SI-units, pixels or an index value in a specified range.

After the at least one quantity of interest has been determined, the result is in an embodiment at step 150 compared to at least one predetermined threshold value for the quantity of interest in order to ascertain that the lime kiln is operating in a desired manner. The at least one quantity of interest is, in an embodiment, sent to a control system. In an embodiment, the at least one quantity of interest is displayed on a user interface element, such as a display. In an embodiment, the determined at least one quantity of interest is used to adjust, or control, the burning process of the lime kiln for example by adjusting the air distribution in the burner or by adjusting the fuel amount.

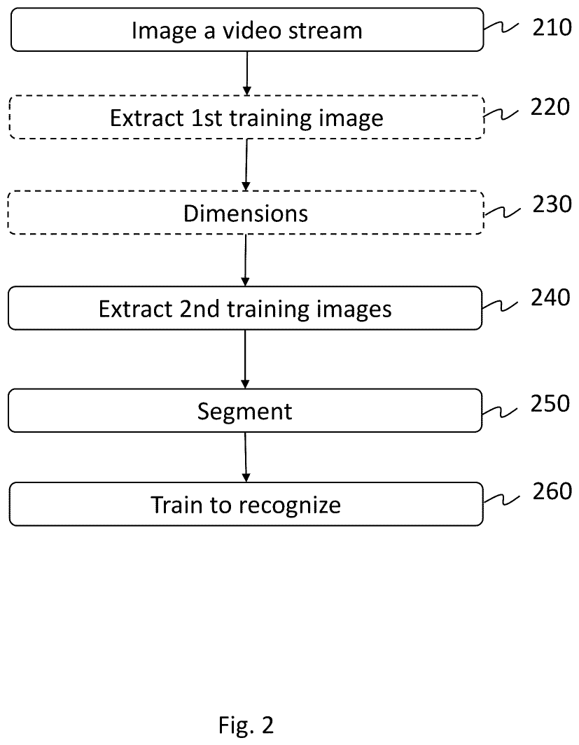

FIG. 2 shows a further flow chart according to an example embodiment of the invention. FIG. 2 shows the method for pretraining the algorithm for determining the at least one area of interest according to an example embodiment of the invention. At step 210, a video stream showing the burner end of a lime kiln is imaged. In an embodiment, the imaging means for providing the video stream comprise at least one means selected from the group of digital video camera, a digital still camera configured to capture consecutive still images, a high-speed video camera and thermal imaging means.

At step 220, a reference image is extracted from the video stream imaged at step 210. The extracted reference image, or at least a portion thereof, depicts the burner end of the lime kiln. The reference image is extracted from the video stream using convenient procedures in image and video processing. At step 230, a size in SI-units for pixels of the reference image is determined using known dimensions of the burner end of the lime kiln depicted in the reference image. In an embodiment, steps 220 and 230 are skipped, should the determination of the pixel sizes have been previously carried out and/or should the corresponding size in SI-units be known.

At step 240, a plurality of training images is extracted from the video stream imaged at step 210. The plurality of training image is extracted from the video stream using convenient procedures in image and video processing. In an embodiment, the plurality of training images comprises images from different operating situations.

For each image of the plurality of training images, at least one characteristic portion is segmented into separate images of the plurality of training images at step 250. In an embodiment, the at least one characteristic portion comprises white flame portion, black flame portion, pipe area and/or lime bed. In an embodiment, the segmenting is carried out manually, i.e. a user, or operator, carries out the segmenting for example by selecting the characteristic portions from each image.

At step 260 the algorithm is trained to recognize the characteristic portions using the plurality of training images that have been segmented at step 250 as a training data set. In an embodiment, the algorithm comprises a deep learning neural network. In a further embodiment, the recognition, or detection, of characteristic portions is based on further image analysis methods such as thresholding and morphological operations. In a further embodiment, different methods can be used together or separately.

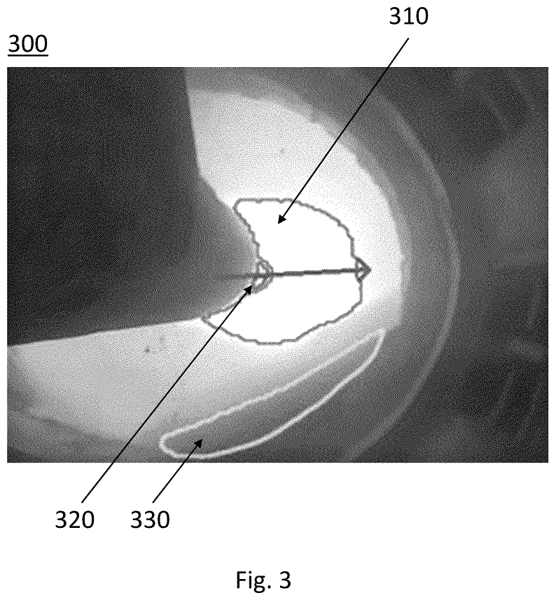

FIG. 3 shows an example image 300 used in the method according to an example embodiment of the invention. The image 300 depicts the burner end of the lime kiln. FIG. 3 shows example characteristic portions and areas of interest 310, 320 and 330 determined from the image showing the characteristic portions according to the method of the invention. In the example of FIG. 3, the area of interest 310 comprises white flame portion, the area of interest 320 comprises black flame portion and the area of interest 330 comprises the lime bed.

Without in any way limiting the scope, interpretation, or application of the claims appearing below, a technical effect of one or more of the example embodiments disclosed herein is providing a monitoring method with which reacting to disturbances of the burning can be recognized and reacted to substantially faster. Another technical effect of one or more of the example embodiments disclosed herein is the provision of a more stable burning process by adjusting fuel and air feeding. Another technical effect of one or more of the example embodiments disclosed herein is a more stable calcining process resulting in a balanced production of white liquor. A still further technical effect of one or more of the example embodiments disclosed herein is a more environmentally friendly operation.

If desired, the different functions discussed herein may be performed in a different order and/or concurrently with each other. Furthermore, if desired, one or more of the before-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications which may be made without departing from the scope of the present invention as defined in the appended claims.

1. A method for monitoring a flame of a burner of a lime kiln, comprising:
imaging a video stream showing the burner end of the lime kiln to generate an imaged video stream;
extracting at least one image from the imaged video stream;
determining, using a pretrained algorithm, from the at least one image at least one area of interest, wherein the at least one area of interest comprises a part of the at least one image showing an area comprising at least one characteristic portion of the flame and/or burner end;
calculating the area of the at least one characteristic portion based on pixels in the at least one area of interest; and
determining at least one quantity of interest based on the calculated area of the at least one characteristic portion.

2. The method according to claim 1, further comprising comparing the calculated area and/or the at least one quantity of interest with predetermined threshold values.

3. The method according to claim 1, further comprising displaying the at least one quantity of interest on a user interface element.

4. The method according to claim 1, further comprising adjusting the operation of the burner based on the at least one quantity of interest.

5. The method according to claim 1, wherein the pretrained algorithm is created by imaging a video stream showing the burner end of the lime kiln; extracting a plurality of training images from the imaged video stream and segmenting each image of the plurality of training images into areas of interest, wherein the area of interest for at least one image comprises the interior of the lime kiln; and training an algorithm to recognize the areas of interest from the segmented images.

6. The method according to claim 5, further comprising extracting a reference image from the imaged video stream; and determining using known dimensions of the lime kiln visible in the reference image corresponding size in Si-units for a pixel of the reference image.

7. A system for monitoring a flame of a burner of a lime kiln, comprising a video imaging device; and
a processor configured to:
image a video stream from the imaging device showing the burner end of the lime kiln to generate an imaged video stream;
extract at least one image from the imaged video stream;
determine, using a pretrained algorithm, from the at least one image at least one area of interest, wherein the at least one area of interest comprises a part of the at least one image showing an area comprising at least one characteristic portion of the flame and/or burner end;
calculate the area of the at least one characteristic portion based on the pixels of the at least one area of interest; and
determine at least one quantity of interest based on the calculated area of the at least one characteristic portion.

8. A control system for controlling a burner of a lime kiln, comprising the system of claim 7, wherein the processor is further configured to cause adjusting the operation of the burner based on the at least one quantity of interest.

9. A computer program product comprising a computer-executable program code that when executed by a processor causes carrying out the method of claim 1.

10. A non-transitory memory medium comprising the computer program product of claim 9.
